(19) United States
(12) Patent Application Publication
(10) Pub. No.: US 2005/0268319 A1
(43) Pub. Date: Dec. 1, 2005

(54) Remote passenger control unit and method for using the same

(75) Inventor: Kenneth A. Brady JR., Trabuco Canyon, CA (US)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: Thales Avionics, Inc., Irvine, CA (US)

(21) Appl. No.: 11/057,585

(22) Filed: Feb. 14, 2005

Related U.S. Application Data
(60) Provisional application No. 60/545,305, filed on Feb. 17, 2004.
(60) Provisional application No. 60/545,062, filed on Feb. 17, 2004.

(51) Int. Cl. E05F 15/00

(52) U.S. Cl. 725/76; 725/77

(57) ABSTRACT

A system and method for connecting control devices for display and computing equipment of in-flight entertainment systems (IFESs) in a physical location independent manner in environments where the control devices cannot be co-located and directly connected to the display/computing equipment, such as on an aircraft or other vehicle having space restrictions. More particularly, the present invention relates to a system and method for enabling the use of improved passenger control units (PCU) including control devices such as pointing devices, keyboards, joysticks, and game controllers, and so on, with interactive in-flight entertainment systems.

### CROSS-REFERENCE TO RELATED PATENT APPLICATIONS

This application claims benefit under 35 U.S.C. § 119(e) from U.S. Provisional Patent Application No. 60/545,305, filed Feb. 17, 2004, and from U.S. Provisional Patent Application No. 60/545,062, filed Feb. 17, 2004, the entire content of each being incorporated herein by reference.

### BACKGROUND OF THE INVENTION

1. Field of the Invention

The present invention relates to control devices for display and computing equipment for use in environments where the control devices cannot be co-located and directly connected to the display/computing equipment, such as on an aircraft or other vehicle having space restrictions. More particularly, the present invention relates to improved passenger control units (PCU) including control devices such as pointing devices, keyboards, joysticks, and game controllers, and so on, for use with interactive in-flight entertainment systems.

2. Description of the Related Art

Many vehicles today, in particular, aircraft, include in-flight entertainment systems (IFES) or passenger information systems with which the passengers can interact via control device, such as control buttons on the armrests of the seats or other plug-in devices. More sophisticated IFES are being developed and employed on aircraft to further enhance the passengers' flight experience. Such sophisticated systems allow for and in some instances require the use of more complex control devices such as keyboards, joysticks, game controllers, trackballs and so on.

The traditional method for enabling control devices to interface to display and other computing equipment typically employs a dedicated communications interface. These types of interfaces have evolved from the early RS-232 interface, to the later PS2 interface which was pioneered by IBM, and finally, to the current Universal Serial Bus (USB) interface. As can be appreciated by one skilled in the art, RS-232 and PS2 interfaces are dedicated, wired connections between the control device and the computing equipment. The more recent USB interface is a dedicated, wired connection between the computing equipment and multiple peripheral devices, including control devices, through a fan-out/fan-in device called a USB hub.

A USB interface and hub arrangement works well in a dedicated office type environment where there is a single piece of display and/or computing equipment to which one or more control devices can be easily connected. However, this type of arrangement can prove cumbersome and inefficient in limited-space environments such as passenger vehicles. For example, in passenger transport vehicles such as busses, passenger trains, or commercial aircraft, multiple seats 10 are typically arranged in compact seat groups identified by row numbers and seat letters within the passenger occupied space as shown in FIG. 1. Systems that provide entertainment and information services to passengers on an individual basis, which are typically referred to as “interactive” systems, require display and computing equipment, and a control device, for each passenger.

Space limitations typically require the display/computing equipment to be located on the back of the seat in front of each passenger or divided between the back of the seat and an under-seat electronics box, typically referred to as the Seat Electronics Box or SEB 14. Control devices 16 are typically mounted on the arm 18 of the passenger seat 10 for convenience and because seat-back controls are generally considered a potential annoyance to a passenger setting in the forward seat. Such control devices 16 can be fixed in place or tethered for ease of use. The display/computing equipment 20 for a seat 10, for example, in seat group of Row 2 is typically mounted to the rear of the seat back 22 of a seat 10 in seat group of Row 1 directly in front of that seat 10 as shown in FIG. 2.

FIG. 2 further illustrates an example of the typical interconnect strategy employed in these systems. The interconnection concept can be divided into two categories: distribution and in-seat. Power, data, and Radio Frequency (RF) signals are typically provided from centrally located sources to the columns of seat groups. At least one SEB 14 is typically present in each seat group, and distribution wiring 24 is typically run from the head-end to the first SEB 14 in a column. Further distribution wiring 24 is run from each SEB 14 to the next SEB 14 in the column. This architecture is documented in the industry standard ARINC 628, Part 4a, the contents of which is incorporated herein by reference. For in-seat interconnection, the display/computing equipment 20 and control device 16 are typically each connected to a common SEB 14, as shown in FIG. 3, and individual wiring is provided from the SEB 14 to each attached component for each function. Further feed back and feed forward cable arrangements are illustrated in FIGS. 4 and 5.

As can be appreciated from FIGS. 3 through 5, because the display/computing equipment 20 is in one seat group, for example, a seat group in Row 1, and the control device for that equipment is in a different seat group, for example, a seat group in Row 2, a significant amount of additional seat group to seat group wiring, such as a feed forward cable or control device or feed back cable, is required to connect these to the same SEB 14. However, additional wiring has several important disadvantages. For example, in weight sensitive applications such as in-flight entertainment, extra pounds of wire cost in both fuel and aircraft carrying capacity. Also, extra wiring that is potentially exposed as it passes from seat 10 to seat 10 is especially vulnerable to physical damage and thus lowers system reliability. Furthermore, the complexity of this additional wiring makes maintenance functions and reconfiguration functions more complex and time-consuming. In addition, the ability to provide alternate control in the event of a control device or wiring failure is very limited due to the required physical interconnection.

Several conventional solutions exists which attempt to eliminate the above disadvantages. For example, attempts have been made to use smaller gauge wire to reduce the adverse size and weight impact of the extra wire. However, smaller wires are more difficult to repair and in most cases, if the wires are smaller than 24 AWG, they typically cannot be repaired and entire cable harnesses must be replaced, which results in a significant extra cost. Extra protection and careful routing can minimize the potential for wire damage, but the protective materials generally creates heavier and longer interconnect wiring and the rerouting of cables makes the wiring much more difficult and time consuming to install. Also, special tools and additional training can help reduce the time required for maintenance and reconfiguration, but impose additional costs to operators of the systems.

Although these conventional solutions may be somewhat suitable for solving the disadvantages associated with wiring techniques, they introduce their own disadvantages and problems as discussed above. Furthermore, as can be appreciated from FIG. 6, these wiring techniques do not improve the ability to connect other control devices, such as keyboards, pointing devices, joysticks trackballs and so on, to a display/computing equipment 20. Rather, these control devices still need to be connected directly to the display/computing equipment 20 in conventional systems.

Accordingly, a need exists for an alternative system and method for interconnecting control devices 16 to display/computing equipment 20 and SEBs 14, especially in restricted environments such as IFES.

### SUMMARY OF THE INVENTION

The embodiments of the present invention described herein permit display/computing equipment and control devices to be physically connected to the closest SEB without regard to the passenger to be serviced by the device by employing networking protocol techniques in or for use with the SEBs. The basic communications network is used as a pathway for passenger control device packets to tunnel from the remote control device to the computer under control, thus eliminating extra wiring and enabling the control devices to be “physical location independent”.

By permitting this local connection of control devices and SEBs, the disadvantages arising from additional cost, weight, and complexity of the seat-to-seat wiring are eliminated. In such an arrangement, no extra seat-to-seat wiring is used, and each seat group can be assembled as a stand-alone assembly, thus reducing maintenance and reconfiguration efforts while reducing the possibility of wire damage. Moreover, because the connection between the display/computing equipment and control device is logical rather than physical, the system is very adaptable so that alternative control devices such as keyboards, pointing devices, joysticks and so on, can be connected with ease from locations other than the typical location of the control device.

Hence, these different types of control devices can be combined together independently from the physical connections provided on the display/computing device. The display/computing device listens for the control packets and translates them back as if the device or devices were physically attached. Therefore, additional devices can be attached and used without having to have additional physical “ports”. Also, if a control device dedicated to a particular seat, such as the control device in the arm of the seat, becomes inoperable, an alternate control device can be connected to the display/computing equipment with ease for use by the passenger.

These features are further realized by providing a system and method for connecting a least one control device to an in-flight entertainment system (IFES) of a vehicle, such as an aircraft. The system and method employ a conversion unit that converts control signals received from one or more control devices via, for example, respective universal serial bus (USB) ports, into standard addressable internet protocol formatted data, such as TCP/IP data, for delivery over a network of the IFES to a component, such as a video display unit, of the IFES having an address corresponding to the address of the data so that the data controls the component in accordance with the control signals generated by the control device or devices. The conversion unit can be disposed in a seat electronics box (SEB) of the IFES. Each SEB can include at least one USB driver that receives the control signals from a respective USB port and to provide the control signals to an application in the conversion unit that converts the control signals into the standard addressable internet protocol formatted data. The control device can be any type of control device, such as a push-button control, a keyboard, a joystick or a mouse.

The above advantages of the present invention can further be realized by deploying an in-flight entertainment system (IFES) having these features into a vehicle such as an aircraft. The IFES comprises a plurality of conversion units, each adapted to convert control signals received from a least one control device associated therewith into standard addressable internet protocol formatted data, such as standard TCP/IP data, a plurality of display units, and network providing connection between the conversion units and the display units. Each conversion unit delivers its standard addressable internet protocol formatted data over the network to a display unit having an address corresponding to the address of the data so that the data controls the display unit in accordance with the control signals generated by the control device.

Each of the conversion units can be disposed in a respective seat electronics box (SEB) associated with a seat group of the vehicle, and each of the display units is associated with a seat of the vehicle. The IFES can further include at least one universal serial bus (USB) port, associated with each seat of the vehicle, such that each UBS can be connected to a respective control device so that the respective control device provides respective control signals to a conversion unit of the SEB associated with the seat group containing that seat via the USB. In this regard, each SEB can comprise at least one USB driver that receives the control signals from a respective USB port and to provide the control signals to an application in its conversion unit that converts the control signals into the standard addressable internet protocol formatted data. The control devices comprises can be a push-button control, a keyboard, a joystick and a mouse.

Accordingly, the embodiments of the present invention overcome the disadvantages associated with the conventional wiring techniques.

### BRIEF DESCRIPTION OF THE DRAWINGS

The above objects and advantages of the present invention will become more apparent by describing in detail a preferred embodiment thereof with reference to the attached drawings in which:

FIG. 1 is a conceptual diagram of a typical seating arrangement, such as that employed in a passenger aircraft;

FIG. 2 is a conceptual diagram illustrating an example of seat equipment and their interconnections for two seat groups shown in FIG. 1;

FIG. 3 is a conceptual diagram illustrating an example of a feed forward cable arrangement for interconnecting seat equipment for two seat groups shown in FIG. 2;

FIG. 4 is a conceptual diagram illustrating an example of a feed back cable arrangement for interconnecting seat equipment for two seat groups shown in FIG. 2;

FIG. 5 is a conceptual diagram illustrating another example of a feed forward cable arrangement for interconnecting seat equipment for two seat groups shown in FIG. 2;

FIG. 6 is a conceptual diagram illustrating an example of a conventional manner in which other control devices, such as a joystick, pointing device and keyboard, are connected to display/computing equipment employed in a seat group as shown in FIG. 2;

FIG. 7 is a conceptual diagram illustrating an example of a system according to an embodiment of the present invention for interconnecting seat equipment for two seat groups, such as those shown in FIG. 2;

FIG. 8 is a conceptual diagram illustrating an example of a manner in which the system according to the embodiment of the present invention as shown in FIG. 7 enables other control devices, such as a joystick, pointing device and keyboard, to be connected to display/computing equipment employed in a seat group as shown in FIG. 2; and

FIG. 9 is a conceptual diagram illustrating an example of the manner in which the other control devices shown in FIG. 8 communicate with the display/computing equipment employed in a seat group as shown in FIG. 2 according to an embodiment of the present invention.

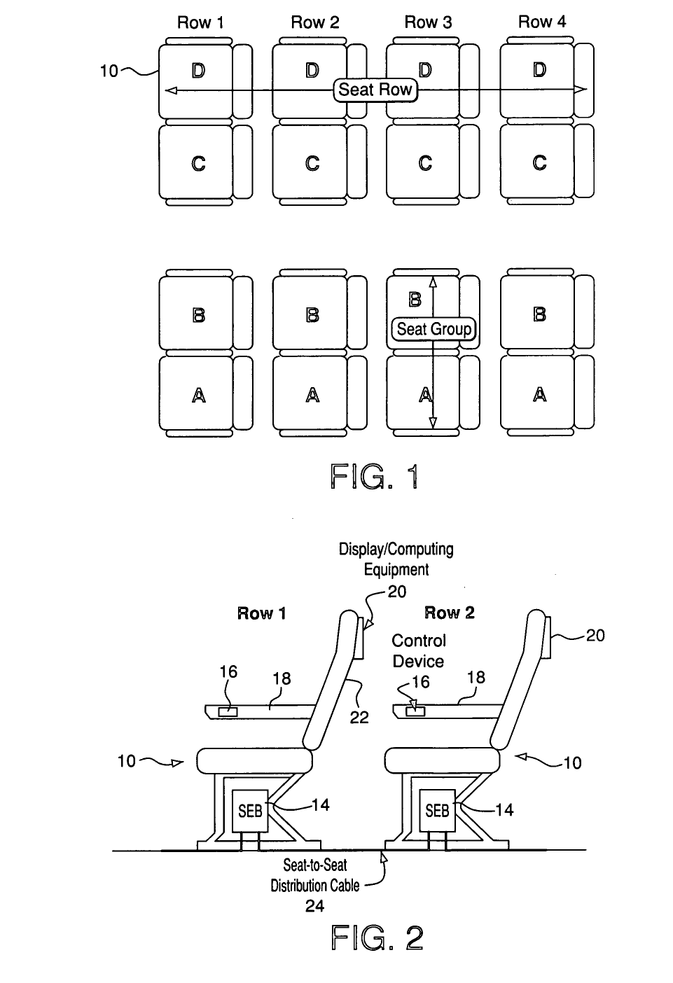

### DETAILED DESCRIPTION OF THE PREFERRED EMBODIMENTS

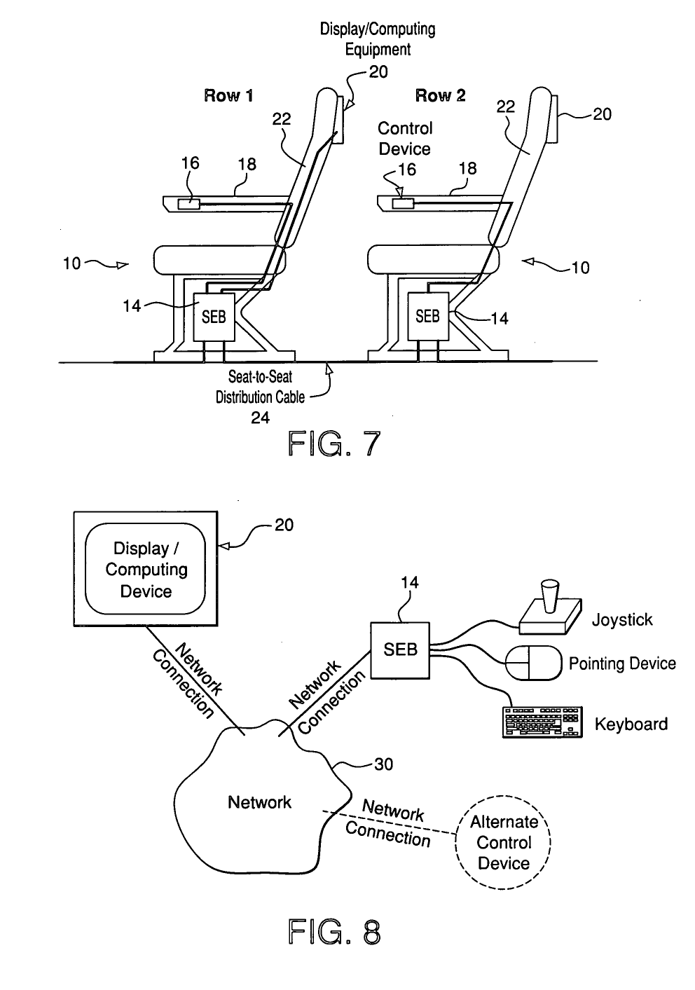

A seat group arrangement employing a system and method for interconnecting seat equipment according to an embodiment of the present invention is shown conceptually in FIG. 7. As with the arrangement shown in FIG. 2 as discussed above, each seat group includes an under-seat SEB 14. A passenger control unit (PCU) for each seat 10 includes a control device 16 that is typically mounted on the arm 18 of the passenger seat 10 for convenience, and can be fixed in place or tethered for ease of use. The display/computing equipment 20 for a seat 10, for example, in a seat group of Row 2 is typically mounted to the rear of the seat back 22 of a seat 10 in a seat group of Row 1 directly in front of that seat 10 as shown in FIG. 2.

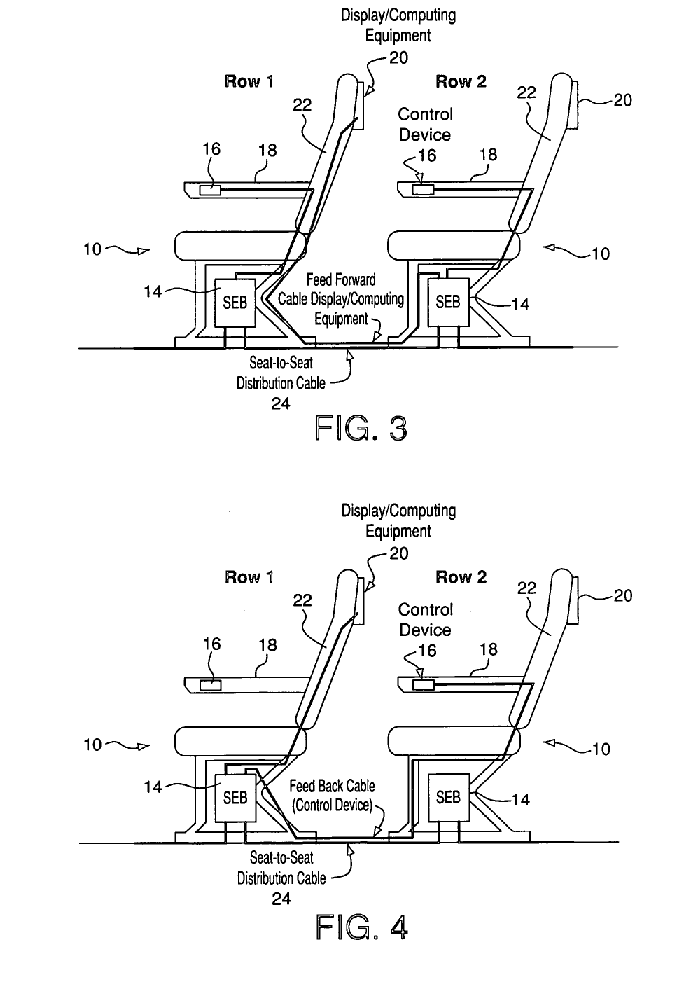

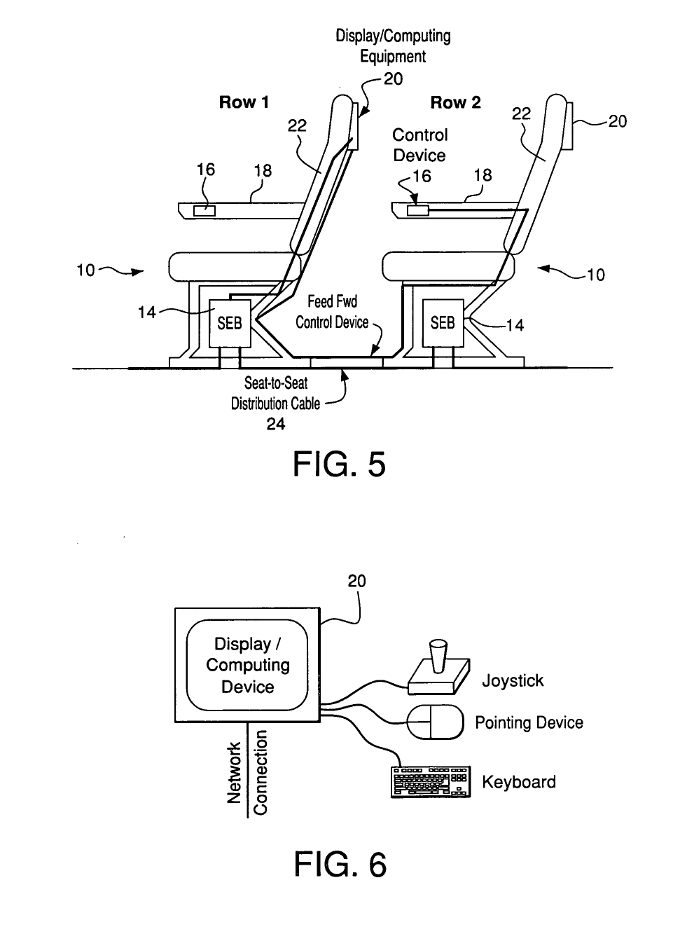

Unlike the conventional arrangements shown in FIGS. 3 through 5 as discussed above, the system shown in FIG. 7 does not require that wires be deployed to physically and directly connect the control devices 16 to a respective display/computing equipment 20. Rather, according to an embodiment of the present invention, a control device 16 is connected to a conversion device that can be employed, for example, in an SEB 14, and which converts the control messages provided by the control device 16 to the appropriate network tunnel protocol. The network protocol routes the “encapsulated” control message from the conversion device to the previously established network node being controlled, such as particular display/computing equipment 20. The device being controlled receives the “encapsulated” control message from the network and converts it back into the format as if it were a locally connected control device. Thus, from the perspective of applications running on the computer of, for example, the display/computing equipment 20, the computer appears to have a local control device.

Preferably, the same protocol is used between the control device 16 and the SEB 14, especially since the control device 16 is used as the input for the display/computing equipment 20, however, different protocols can be used. Moreover, because the control devices 16 are “physical location independent”, it is not necessary for the display/computing equipment 20 to be located on a different seat from the control device 16. Rather, the system enables a control device 16 to control any display/computing equipment 20, regardless of its location.

The embodiment of the present invention is not limited any particular network such as an Ethernet, but rather, can use any network such as a token ring, arcnet, 1394 and so on, or can be employed in a wireless network like such as an IEEE 802.11(a), (b) or (g) type network. Also, the embodiment of the present invention also need not require the use of a USB between the control device 16 and the network conversion device, but can use other interfaces such as RS-232, PS/2, RS485 and so on.

As can be appreciated by one skilled in the art, USB is one of the most practical protocols available and is adaptable for use with most of the currently desired control devices such as pointing devices, keyboards, joysticks and so on. Furthermore, as shown in FIG. 8, protocols employed by the embodiment of the present invention enables these types of control devices to be physically connected to the SEB 14, for example, instead of directly to the display/computing equipment 20, thus allowing much more freedom for the user.

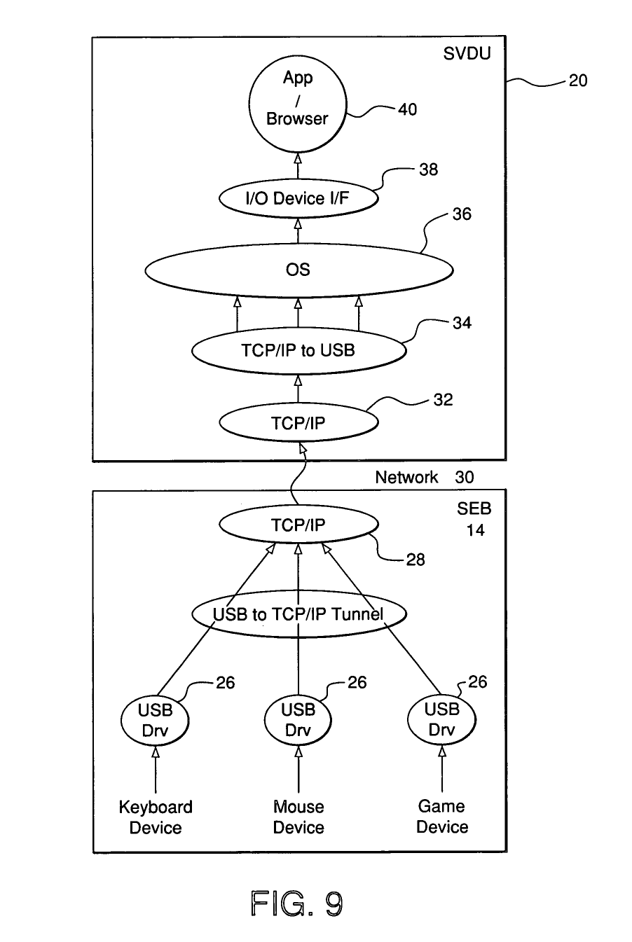

Specifically, as shown in more detail in FIG. 9, a keyboard or pointing devices such as a keyboard, mouse and joystick or other game controller can be plugged into a standard USB port that can be part of the PCU and conveniently located at each seat 10, such as in the arm 18 of the seat 10 or at any other readily accessible location. Each seat can include a plurality of USB ports (e.g., three in this example) to allow for connection of multiple devices simultaneously. The function of a pointing device is provided in a variety of ways. The display/computing equipment 20 can be a smart video display unit (SVDU) having a touch panel acting as a pointing device, a Tethered Digital Passenger Control Unit (TDPCU) can provide a pointing device, or a handout pointing device (mouse or trackball) can be plugged into the available USB ports of the seat 10.

It is noted that a keyboard alternatively can be integrated into the PCU, provided as a graphic with the touch panel, provided as a hand-out device which is plugged into the USB connection on either an SVDU (the display/computing equipment 20 described above), or integrated into an element of the seat such as the tray. One of the cleanest solutions to integrate a keyboard into the food tray is to provide a bi-fold tray with the keyboard located on the side which is exposed when the tray is folded in half. This approach protects the keyboard from inadvertent activity when the tray is being used as a food tray (opened up) and is also protected when the tray is fully stowed. In either of these configurations, the manner in which the commands from the keyboard are handled by the embodiments of the present invention described herein are similar in that the keyboard is “physical location independent” from the display/computing equipment 20 that it controls.

It is further noted that the control device 16 can use a USB interface to communicate with the SEB 14. The PCU can also serve as a USB Hub to extend the USB interface on the USB to the additional peripheral devices such as keyboards, mice, joysticks, VoIP telephones, memory sticks, and so on as shown in FIG. 9. Further, the PCU may be separated into two independent controllers, one mounted in a fixed position on the seat, such as control device 16, and a second mounted as a tethered controller for ease of operation. One controller would serve as the USB hub for the second controller so that a single USB interface is used for the SEB 14. The PCU can also be used to control other, non-IFE equipment such as seat motors, seat massage systems, and additional passenger lighting, to name a few. The system according to the embodiment of the present invention enables all such controllers 16 to be adaptable with the network via the SEB 14 using the conversion device and protocol discussed herein.

In addition to the conventional control devices 16 as discussed above, a variety of PCUs can be employed ranging from a simple audio selection PCU to a sophisticated Tethered Digital Passenger Control Unit (TDPCU). The PCU may incorporate any and/or all of the following features such as LCD or LED channel display, Channel Control Buttons (Up/Dn), Volume Control Buttons (Up/Dn), Mode button or buttons, Passenger Service Buttons (Reading Light Toggle, Attendant Call, Call Cancel), Game Control Buttons, Mouse Simulation (touchpad or joystick) and Joysticks. The PCUs can also employ a Credit Card Reader, Smart Card Reader, Telephone Microphone and Speaker, a numeric keypad to facilitate numeric entry such as telephone numbers, credit card numbers, and so on, a full keyboard for use in general data entry such as addresses, URLs and so on, as well as a tethered cord reel permitting extension for ease of use, an RJ11 connector or other connector for connection to a modem, and an RJ45 connection or other connection for connecting an external Ethernet Device. All of these functions can be supported by the embodiments of the present invention described herein.

Returning to FIG. 9, as indicated, each SEB 14 includes a plurality of USB drivers 26 that each receives input from the device connected to its respective USB port. Hence, each USB driver 26 outputs signals representative of the commands provided by the device, such as mouse movement or a mouse click, data entry via a keypad, joystick movement and so on. The USB drivers 26 provide these signals to a TCP/IP application 28 that can reside, for example, in what is referred to as the conversion unit of the SEB 14. The TCP/IP application 28 formats these signals into standard addressable IP packets and provides these packets over a network 30 that includes, for example, the seat-to-seat distribution cable 24, to another TCP/IP application 32 according to their packet addresses. Also, although not shown explicitly in this figure, the control devices 16 in the arms 18 of the seats 10 also provide signals to the TCP/IP application 28 via, for example, a USB interface as described above, and the TCP/IP application 28 thus handles those signals in a manner similar to the signals provided by the USB drivers 26 to format those signals into standard addressable IP packets and provide the packets over a network 30 to another TCP/IP application 32 according to their packet addresses. The TPC/IP application 32 can reside in a smart video display unit (SVDU), which can be the display/computing equipment 20 as discussed above that operates as an addressable video display.

It is noted that as can be appreciated by one skilled in the art, the USB ports 26 are associated with a particular SVDU 20 during a mapping process where the USB ports 26, SVDUs 20, control devices 16, SEBs 14 and any other component that generates control signals that are formatted into the addressable IP packets, converts the control signals into the IP packets or vice-versa, or which are involved in routing or receiving the IP packets, are associated with a unique IP address. An example of such a mapping process, referred to as an IP sequencing process, is described in a U.S. Provisional Patent Application No. 60/545,061, filed on Feb. 17, 2004, entitled “IP Sequencing”, the entire content of which is incorporated herein by reference. Accordingly, the destination IP address that the TCP/IP application 28 assigns to the TCP/IP packets correspond to the IP address that was assigned to the SVDU 20 with which the USB ports 26 are associated during the IP mapping process.

As further indicated in FIG. 9, the TCP/IP application 32 in the SVDU 20 communicates the data packets to an application 34 that translates the data packets to USB signals and provides those USB signals to the operating system 36 (e.g., a Linux operating system) of the SVDU 20. The operating system 36 provides the USB signals to an application 40 via an I/O or other interface (I/F) 38 as indicated. Accordingly, the TCP/IP and TCP/IP to USB applications described above enable the control devices to communicate with the screen control applications of the SVDU 20 as would a standard USB device that would have a direct physical connection with the SVDU 20. Therefore, no modification is necessary with respect to the applications being run on the SVDU 20 or to the packetized control inputs in order to support the different types of control devices.

Details of the types of controllers that can be connected to the SEB 14 and used in conjunction with the system according to the embodiment of the present invention described above will now be discussed.

In a typical IFES, an audio jack is provided in each seat 10 for a passenger headset. It is noted that for purposes of the description herein, the term “in-flight entertainment system” or “IFES” is not limited to an IFES for use on an aircraft, and the term “flight” is not limited to the conventional meaning as it would apply to aircraft flight. Rather, the terms “in-flight entertainment system” and “IFES” refer to any such system that can be employed in any type of vehicle, such as a bus, train, ship, car, airplane or aircraft, and need not be limited merely to vehicle use or use during travel. The audio system supports independent left and right audio for stereo presentation, and offers a microphone option to support telephone functionality. The audio system further offers noise cancellation technology to reduce the effect of aircraft noise on the listening experience. The audio system can select a variety of audio sources including broadcast FM audio, the audio associated with a broadcast CATV, the audio associated with an overhead video program, the audio associated with Satellite TV, the audio from a selected Audio On Demand program, the audio associated with a selected Video On Demand program, the audio from an external source such as a walkman, MP3 player, and so on, the audio associated with a game, and the audio associated with a telephone call, to name a few. According to an embodiment of the present invention, the audio jack is connected to the SEB 14. Hence, the protocol used in the conversion unit enables the SEB 14 to provide the different types of audio mentioned above, and further supports telephone functionality as well as any other microphone technology.

As discussed above, a typical IFES also provides a Video Display Unit (VDU) for each passenger seat 10 as part of, for example, the display/computing equipment 20. Two possible implementations include simple VDU and Smart VDU. The simple VDU presents any available NTSC video program. In addition to the video presented by the simple VDU, the Smart VDU (SVDU) presents internally generated graphics and internally decoded video. A broadcast video system can select a variety of video sources including video associated with a broadcast CATV program, the video associated with an overhead video program, the video associated with satellite TV, the video associated with a Video On Demand Program, the video associated with an accessed web page, the video associated with a video announcement, the video associated with a forced video message, the video associated with a video conference, and the video associated with a camera. Other types of video include the video used to facilitate system operation such as dialing a telephone, entering text and so on, as well as the video produced by an On-Screen display device in the SEB 14, the video associated with an external source such as a camcorder, DVD player and so on, and any other types of video sources. The system according to the embodiment of the present invention enables such video to be delivered via the SEB 14 using the conversion device and TCP/IP as discussed above.

For example, the simple Video Display Unit can accept NTSC video and power from the SEB 14 and provides test status back to the SEB 14 via the TCP/IP applications 32 and 28. The Smart VDU adds an Ethernet Interface as well as an Audio Output to the SEB 14. The Video Display Units typically have a pair of brightness control buttons, but can have additional buttons added to facilitate operation and navigation. A high resolution touch panel can also be used for the Smart VDUs as well. The touch panel can be used in conjunction with graphic images to provide services like web browsing, virtual keyboard entry, telephone dialing, credit card entry and so on. The VDU also provides a USB host interface into which peripheral devices such as keyboard, mouse, joystick, memory stick, credit card reader or smart card reader can be connected. The Smart Video Display Unit (SVDU) can be fitted with a small camera (Web Cam) to facilitate services such as on or off-aircraft video conferencing. All of the above video devices and their interaction with the IFES, for example, can be controlled via the SEB 14 using the conversion devices, applications and protocols as described above.

In addition, it is noted that Passenger Electronics Devices (PED) often need a power connection and a data network connection. The system according to the embodiment of the present invention described herein can provide the following data network connections either integrated into other seat components (like the PCU) or as an independent seat attachment such as a USB Type B connection, an RJ45 Ethernet connection, and an RJ11 Modem connection.

The system may be provided with the ability to provide 115 VAC, 60 Hz power for a PED. The connection for power consists of a multi-format AC plug accommodating the power connectors from a variety of countries. The power system in conjunction with the AC plug must provide a set of safety features which prevent power from being presented unless a proper connector is fully inserted. The utilization of AC power plugs will be fairly low (<20%) however the aircraft installation should guarantee that the capacity of the aircraft power system will never be exceeded. To accomplish this, the power system should monitor current power use and limit the system to a value at or below the amount of power allocated to the system by the aircraft installation design. The PED AC power and PED Data interfaces can be combined together into one assembly and be co-located on the passenger seat. This provides a common location for all PED related functions.

As the seat components become more numerous and interdependent, the desirability of having independent power supplies for each of the components becomes low. Other designs may consider having a single AC to DC conversion component which all in-seat components operate from. Thus the IFE components (SEB, VDU, PCU), seat component (motors, massage units, lights), and power system (PED Power) would all use a common AC conversion stage.

While this invention has been particularly shown and described with reference to preferred embodiments thereof, the preferred embodiments described above are merely illustrative and are not intended to limit the scope of the invention. It will be understood by those skilled in the art that various changes in form and details may be made therein without departing from the spirit and scope of the invention as defined by the appended claims.

1. A system for connecting a least one control device to an in-flight entertainment system (IFES), the system comprising:
a conversion unit, adapted to convert control signals received from the control device into standard addressable internet protocol formatted data for delivery over a network of the IFES to a component of the IFES having an address corresponding to the address of the data so that the data controls the component in accordance with the control signals generated by the control device.

2. A system as claimed in claim 1, wherein:
the conversion unit is disposed in a seat electronics box (SEB) of the IFES.

3. A system as claimed in claim 1, wherein:
the conversion unit is adapted to convert respective control signals received from a plurality of the control devices into respective standard addressable internet protocol formatted data for delivery to a respective component of the IFES having an address corresponding to the address of the respective data so that the respective data controls the respective component in accordance with the control signals generated by the respective control device.

4. A system as claimed in claim 1, wherein:
the component is a video display unit, and the data controls operation the video display unit based on the control signals.

5. A system as claimed in claim 1, wherein:
the protocol is standard TCP/IP.

6. A system as claimed in claim 1, further comprising:
at least one universal serial bus (USB) port, adapted to connect to the control device so that the control device provides the control signals to the conversion unit via the USB.

7. A system as claimed in claim 6, wherein:
the conversion unit further comprises at least one USB driver, adapted to receive the control signals from a respective USB port and to provide the control signals to an application in the conversion unit that converts the control signals into the standard addressable internet protocol formatted data.

8. A system as claimed in claim 1, wherein the control device comprises at least one of a push-button control, a keyboard, a joystick and a mouse.

9. An in-flight entertainment system (IFES) of a vehicle, the IFES comprising:
a plurality of conversion units, each adapted to convert control signals received from a least one control device associated therewith into standard addressable internet protocol formatted data;
a plurality of display units; and
a network providing connection between the conversion units and the display units, such that each conversion unit delivers its standard addressable internet protocol formatted data over the network to a display unit having an address corresponding to the address of the data so that the data controls the display unit in accordance with the control signals generated by the control device.

10. An IFES as claimed in claim 9, wherein:
each of the conversion units is disposed in a respective seat electronics box (SEB) associated with a seat group of the vehicle, and each of the display units is associated with a seat of the vehicle.

11. An IFES as claimed in claim 10, further comprising:
at least one universal serial bus (USB) port, associated with each seat of the vehicle, and each UBS is adapted to connect to a respective control device so that the respective control device provides respective control signals to a conversion unit of the SEB associated with the seat group containing that seat via the USB.

12. An IFES as claimed in claim 11, wherein:
each SEB comprises at least one USB driver, adapted to receive the control signals from a respective USB port and to provide the control signals to an application in its conversion unit that converts the control signals into the standard addressable internet protocol formatted data.

13. An IFES as claimed in claim 9, wherein:
each of the conversion units is adapted to convert respective control signals received from a plurality of the control devices into respective standard addressable internet protocol formatted data for delivery to a respective display unit of the IFES having an address corresponding to the address of the respective data so that the respective data controls the respective display unit in accordance with the control signals generated by the respective control device.

14. An IFES as claimed in claim 9, wherein:
the protocol is standard TCP/IP.

15. An IFES as claimed in claim 9, wherein the control device comprises at least one of a push-button control, a keyboard, a joystick and a mouse.

16. An IFES as claimed in claim 9, wherein:
the vehicle is an aircraft.

17. A method for connecting a least one control device to an in-flight entertainment system (IFES), the method comprising:
converting control signals received from a control device into standard addressable internet protocol formatted data; and
delivering the data over a network of the IFES to a component of the IFES having an address corresponding to the address of the data so that the data controls the component in accordance with the control signals generated by the control device.

18. A method as claimed in claim 17, wherein:
the converting is performed by a conversion unit is disposed in a seat electronics box (SEB) of the IFES.

19. A method as claimed in claim 17, wherein:
the converting step converts respective control signals received from a plurality of the control devices into respective standard addressable internet protocol formatted data; and
the delivering step delivers each of the respective data to a respective component of the IFES having an address corresponding to the address of the respective data so that the respective data controls the respective component in accordance with the control signals generated by the respective control device.

20. A method as claimed in claim 17, wherein:
the component is a video display unit; and
the method further includes controlling operation the video display unit based on the data in accordance with the control signals.
